(19) United States
(12) Patent Application Publication
(10) Pub. No.: US 2021/0198527 A1
(43) Pub. Date: Jul. 1, 2021

(54) ADHESIVE-BACKED COMPOSITE INSULATION BOARDS WITH VACUUM-INSULATED CAPSULES

(71) Applicant: Firestone Building Products Company, LLC, Nashville, TN (US)

(72) Inventors: Michael J. Hubbard, Nashville, TN (US); John B. Letts, Carmel, IN (US); Chunhua Yao, Carmel, IN (US)

(21) Appl. No.: 17/202,707

(22) Filed: Mar. 16, 2021

Related U.S. Application Data
(63) Continuation-in-part of application No. 16/301,120, filed on Nov. 13, 2018.
(60) Provisional application No. 62/336,616, filed on May 14, 2016.

(51) Int. Cl. C09J 7/26; C09J 7/38; B32B 7/06; B32B 7/12; B32B 5/18

(52) U.S. Cl. CPC C09J 7/26; C09J 7/38; B32B 7/06; B32B 7/12; B32B 2419/06; C09J 2301/302; C09J 2475/006; B32B 2266/0278; B32B 2307/304; B32B 5/18

(57) ABSTRACT

A method of constructing a roof assembly, the method comprising (i) mechanically affixing a construction board to a roof deck; (ii) providing a composite insulation board including (a) at least one vacuum-insulated capsule; (b) a foam body that encases said at least one vacuum-insulated capsule, said foam body having first and second opposed planar surfaces; (c) a layer of pressure-sensitive adhesive disposed, either directly or indirectly, on one of said first and second opposed planar surfaces; and (d) a release liner removably attached to the layer of pressure-sensitive adhesive; (iii) removing the release liner from the composite insulation board; (iv) mating the composite insulation board to the construction board that is mechanically affixed to the roof deck; and (v) installing a membrane system over the composite insulation board.

This application is a Continuation Application of U.S. Non-Provisional application Ser. No. 16/301,120 filed on Nov. 13, 2018, which is a National-Stage Application of PCT/US2017/032610 filed on May 15, 2017, and claims the benefit of U.S. Provisional Application Ser. No. 62/336,616 filed on May 14, 2016, which are incorporated herein by reference.

### FIELD OF THE INVENTION

Embodiments of the present invention are directed toward composite insulation boards that include vacuum-insulated capsules encapsulated within a foam body, where the foam body carries and adhesive layer for securing the composite board to a building structure.

### BACKGROUND OF THE INVENTION

Vacuum-insulated panels (VIPs) are known. Generally, these panels include a gas-tight enclosure that encapsulates a rigid core that has been air evacuated. The enclosure is typically made of a membrane that prevents the passage of air, and the rigid core is typically a highly-porous material that supports the enclosing membrane against atmospheric pressure once the air is evacuated. Since VIPs prevent the transfer of heat based upon a vacuum, they are very efficient and therefore highly desirable.

While desirable, VIPs can be difficult to install since the ability to secure a VIP into its desired location of use is limited. As the skilled person appreciates, insulation boards are often secured to a roof surface by using mechanical fasteners such as nails and the like. VIPs cannot be secured in this fashion since any mechanical fastener that would pierce the vacuum-sealed enclosure would destroy the evacuated chamber and thereby destroy the insulating properties of the board.

### SUMMARY OF THE INVENTION

One or more embodiments of the present invention provide A composite insulation board comprising (i) a vacuum-insulated capsule; (ii) a foam body that encases said capsule, said foam body having first and second opposed planar surfaces; and (iii) a layer of pressure-sensitive adhesive disposed, either directly or indirectly, on one of said first and second opposed planar surfaces.

Other embodiments of the present invention provide a method of constructing a roof assembly, the method comprising (i) mechanically affixing a construction board to a roof deck; (ii) providing a composite insulation board including a vacuum-insulated capsule; a foam body that encases said capsule, said foam body having first and second opposed planar surfaces; a layer of pressure-sensitive adhesive disposed, either directly or indirectly, on one of said first and second opposed planar surfaces; and a release liner removably attached to the layer of pressure-sensitive adhesive; (iii) removing the release liner from the composite insulation board; (iv) mating the composite insulation board to the construction board that is mechanically affixed to the roof deck; and (v) installing a membrane system over the composite insulation board.

Still other embodiments of the present invention provide a roof assembly comprising (i) a roof deck; (ii) a construction board mechanically affixed to the roof deck; (iii) a composite insulation board adhesively affixed to the construction board, where the composite insulation board includes a vacuum-insulated capsule; a foam body that encases said capsule, said foam body having first and second opposed planar surfaces; and a layer of pressure-sensitive adhesive disposed, either directly or indirectly, on one of said first and second opposed planar surfaces.

### BRIEF DESCRIPTION OF THE DRAWINGS

FIG. 1 is a cross-sectional side view of a construction board according to embodiments of the invention.

FIG. 2 is a cross-sectional side view of a construction board according to other embodiments of the invention.

FIG. 3 is a cross-sectional side view of a roof assembly employing one or more construction boards according to embodiments of the invention.

### DETAILED DESCRIPTION OF ILLUSTRATIVE EMBODIMENTS

Embodiments of the invention are based, at least in part, on the discovery of composite insulation boards that include vacuum-insulated capsules encased within a protective foam, where the boards carry a layer of pressure-sensitive adhesive for securing the boards to a building structure. Because the vacuum-insulated capsules can be damaged or destroyed if mechanical means are employed to secure the boards to a building structure, the boards of the present invention advantageously offer a unique way to adhesively secure the boards, which method avoids puncturing or otherwise damaging the vacuum-insulated capsule. Also, since the boards are adhesively secured to the building structure, the amount of encapsulating foam employed to protect the vacuum-insulated capsules can be minimized because accommodations for mechanical fasteners are not required. As a result, the composite insulation boards of the present invention offer unique installation methods, as well as unique building structures that include these construction boards.

### Board Structure

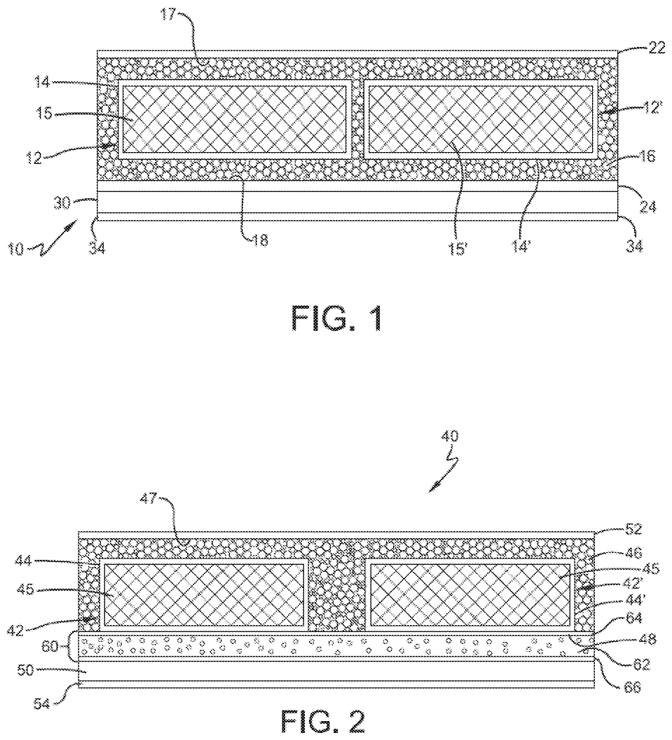

Composite insulation boards according to the present invention can be described with reference to FIG. 1, which depicts a composite insulation board 10, which may also be referred to as construction board 10, includes vacuum-insulated capsules 12, 12′ encased within a foam body 16. Board 10 is generally planar in configuration and includes first planar surface 17 and second planar surface 18. In one or more embodiments, vacuum-insulated capsules 12, 12′, which may be referred to as VIPs 12, 12′ or fragile insulating materials 12, 12′, include an encapsulating element 14, 14′ and a rigid element 15, 15′ respectively. In one or more embodiments, a first facer 22 is secured to first planar surface 17, and a second facer 24 is secured to second planar surface 18. A layer of pressure-sensitive adhesive 30 is disposed on second facer 24 on a planar surface thereof opposite the planar surface where facer 24 is secured to second planar surface 18 of foam body 16. A release member 34 is removably attached to adhesive layer 30 on a planar surface thereof opposite the planar surface of adhesive layer 30 mated to facer 24.

In one or more embodiments, the insulating devices are fabricated into construction boards having a thickness of from about 0.25 inch (0.635 cm) to about 12 inches (30.48 cm), in other embodiments from about 0.5 inch (1.27 cm) to about 10 inches (25.4 cm), in other embodiments from about 1 inch (2.54 cm) to about 6 inches (15.24 cm), and in other embodiments from about 2 inches (5.08 cm) to about 4 inches (10.16 cm). In these or other embodiments, the construction boards can have a width of from about 14 inches (35.56 cm) to 10 feet (3.048 m), in other embodiments from about 1 foot (0.3048 m) to about 8 feet (2.4384 m), and in other embodiments from about 2 feet (0.6096 m) to about 6 feet (1.8288 m). In these or other embodiments, the construction board can have a length of from about 4 feet (1.2192 m) to about 20 feet (6.096 m), in other embodiments from about 6 feet (1.8288 m) to about 18 feet (5.4864 m), and in other embodiments from about 8 (2.4384 m) to about 14 feet (4.2672 m).

### Vacuum-Insulated Capsules

Practice of the present invention is not necessarily limited by the construction of the vacuum-insulated capsules. Indeed, the skilled person can fabricate the vacuum-insulated capsules by using various known techniques. And, once the teachings of this invention are understood, the known techniques can be applied to create the devices of this invention. In one or more embodiments, the vacuum-insulated capsules can be manufactured from materials known for preparing vacuum-insulated panels. For example, and as shown in FIG. 1, vacuum-insulated capsules 12, 12′ include encapsulating element 14, 14′, which may also be referred to as membrane 14, 14′, which surrounds and encapsulates rigid element 15, 15′, which may also be referred to as core 15, 15′. In one or more embodiments, membrane 14, 14′ is sealed to form an encasement or chamber that is impervious or substantially impervious to air. Upon evacuating the chamber, the overall geometric shape of vacuum-insulated capsule 12, 12′ takes on the geometric shape of core 15, 15′.

In one or more embodiments, core 15, 15′ may include a rigid, highly-porous material that supports the membrane walls against atmospheric pressure once the air is evacuated. In one or more embodiments, examples of vacuum-insulated panels include silica (e.g., fumed or precipitated silica), alumina, titania, magnesia, chromia, tin dioxide, glass wool, fiberglass, carbon, aluminosilicates (e.g., perlite), open-cell polystyrene, or open cell polyurethane. In these or other embodiments, core 15, 15′ may include an aerogel such as carbon aerogels, silica aerogels, and alumina aerogels. Other examples of materials that are suitable for forming a core are known in the art as disclosed in U.S. Publication Nos. 2013/0216854, 2013/0216791, 2013/0142972, 2013/0139948, 2012/0009376, 2009/0126600, 2008/0236052, 2004/0058119, 2003/0159404, and 2003/0082357 which are incorporated herein by reference.

In one or more embodiments, membrane 14, 14′ may include a material that is impervious or substantially impervious to the transmission or diffusion of air. For example, membrane 14, 14′, or at least a portion thereof, may include metal foil, such as aluminum foil. In these or other embodiments, membrane 14, 14′ may include a polymeric film such as, but not limited to, a multi-layered film including one or more polymeric layers designed to prevent or at least inhibit the transmission or diffusion of air. In particular embodiments, portions of membrane 14, 14′ may be fabricated from a first material, such as foil, and other portions may be fabricated from a second material, such a polymeric film.

### Foam Body

In one or more embodiments, foam body 16 may include an insulating foam. Examples of insulating foams that can be used to encapsulate VIP 12, 12′ include foamed polystyrene, such as expanded polystyrene, and polyurethane and/or polyisocyanurate foam. Exemplary technology for encapsulating an insulating device is disclosed in PCT/US2015/153568, which is incorporated herein by reference.

In particular embodiments, foam body 16 is a polyisocyanurate or polyurethane foam. As the skilled person will appreciate, polyisocyanurate and/or polyurethane foams can be manufactured by mixing a first stream that includes an isocyanate-containing compound with a second stream that includes an isocyanate-reactive compound. Using conventional terminology, the first stream (i.e., the stream including an isocyanate-containing compound) may be referred to as an A-side stream, an A-side reactant stream, or simply an A stream. Likewise, the second stream (i.e., the stream including an isocyanate-reactive compound) may be referred to as a B-side stream, B-side reactant stream, or simply B stream. In any event, the reaction that ensues produces a foam that, according to one or more kinetic and/or thermodynamic properties, develops over a period of time. Unless otherwise specified, therefore, the term developing foam will be understood to refer to the mixture of the polyurethane and/or polyisocyanurate reactants as they exist prior to cure, which when the reaction mixture is appreciably immobile (e.g., is no longer flowable).

In one or more embodiments, either stream may carry additional ingredients including, but not limited to, flame-retardants, surfactants, blowing agents, catalysts, emulsifiers/solubilizers, fillers, fungicides, anti-static substances, and mixtures of two or more thereof.

### A-Side Stream

In one or more embodiments, the A-side stream may only contain the isocyanate-containing compound. In one or more embodiments, multiple isocyanate-containing compounds may be included in the A-side. In other embodiments, the A-side stream may also contain other constituents such as, but not limited to, flame-retardants, surfactants, blowing agents and other non-isocyanate-reactive components. In one or more embodiments, the complementary constituents added to the A-side are non-isocyanate reactive.

Suitable isocyanate-containing compounds useful for the manufacture of polyisocyanurate construction board are generally known in the art and embodiments of this invention are not limited by the selection of any particular isocyanate-containing compound. Useful isocyanate-containing compounds include polyisocyanates. Useful polyisocyanates include aromatic polyisocyanates such as diphenyl methane diisocyanate in the form of its 2,4′-, 2,2′-, and 4,4′-isomers and mixtures thereof. The mixtures of diphenyl methane diisocyanates (MDI) and oligomers thereof may be referred to as “crude” or polymeric MDI, and these polyisocyanates may have an isocyanate functionality of greater than 2. Other examples include toluene diisocyanate in the form of its 2,4′ and 2,6′-isomers and mixtures thereof, 1,5-naphthalene diisocyanate, and 1,4′ diisocyanatobenzene. Exemplary polyisocyanate compounds include polymeric Rubinate 1850 (Huntsmen Polyurethanes), polymeric Lupranate M70R (BASF), and polymeric Mondur 489N (Bayer).

### B-Side Stream

In one or more embodiments, the B-side stream may only include the isocyanate-reactive compound. In one or more embodiments, multiple isocyanate-reactive compounds may be included in the B-side. In other embodiments, the B-side stream may also contain other constituents such as, but not limited to, flame-retardants, surfactants, blowing agents and other non-isocyanate-containing components. In particular embodiments, the B-side includes an isocyanate reactive compound and a blowing agent. In these or other embodiments, the B-side may also include flame retardants, catalysts, emulsifiers/solubilizers, surfactants, fillers, fungicides, anti-static substances, water and other ingredients that are conventional in the art.

An exemplary isocyanate-reactive compound is a polyol. The term polyol, or polyol compound, includes diols, polyols, and glycols, which may contain water as generally known in the art. Primary and secondary amines are suitable, as are polyether polyols and polyester polyols. Useful polyester polyols include phthalic anhydride based PS-2352 (Stepen), phthalic anhydride based polyol PS-2412 (Stepen), teraphthalic based polyol 3522 (Kosa), and a blended polyol TR 564 (Oxid). Useful polyether polyols include those based on sucrose, glycerin, and toluene diamine. Examples of glycols include diethylene glycol, dipropylene glycol, and ethylene glycol. Suitable primary and secondary amines include, without limitation, ethylene diamine, and diethanolamine. In one or more embodiments, a polyester polyol is employed. In one or more embodiments, the present invention may be practiced in the appreciable absence of any polyether polyol. In certain embodiments, the ingredients are devoid of polyether polyols.

### Catalysts

Catalysts, which are believed to initiate the polymerization reaction between the isocyanate and the polyol, as well as a trimerization reaction between free isocyanate groups when polyisocyanurate foam is desired, may be employed. While some catalysts expedite both reactions, two or more catalysts may be employed to achieve both reactions. Useful catalysts include salts of alkali metals and carboxylic acids or phenols, such as, for example potassium octoate; mononuclear or polynuclear Mannich bases of condensable phenols, oxo-compounds, and secondary amines, which are optionally substituted with alkyl groups, aryl groups, or aralkyl groups; tertiary amines, such as pentamethyldiethylene triamine (PMDETA), 2,4,6-tris[(dimethylamino)methyl]phenol, triethyl amine, tributyl amine, N-methyl morpholine, and N-ethyl morpholine; basic nitrogen compounds, such as tetra alkyl ammonium hydroxides, alkali metal hydroxides, alkali metal phenolates, and alkali metal acholates; and organic metal compounds, such as tin(II)-salts of carboxylic acids, tin(IV)-compounds, and organo lead compounds, such as lead naphthenate and lead octoate.

### Surfactants, Emulsifiers and Solubilizers

Surfactants, emulsifiers, and/or solubilizers may also be employed in the production of polyurethane and polyisocyanurate foams in order to increase the compatibility of the blowing agents with the isocyanate and polyol components. Surfactants may serve two purposes. First, they may help to emulsify/solubilize all the components so that they react completely. Second, they may promote cell nucleation and cell stabilization.

Exemplary surfactants include silicone co-polymers or organic polymers bonded to a silicone polymer. Although surfactants can serve both functions, it may also be useful to ensure emulsification/solubilization by using enough emulsifiers/solubilizers to maintain emulsification/solubilization and a minimal amount of the surfactant to obtain good cell nucleation and cell stabilization. Examples of surfactants include Pelron surfactant 9920, Goldschmidt surfactant 58522, and GE 6912. U.S. Pat. Nos. 5,686,499 and 5,837,742 are incorporated herein by reference to show various useful surfactants.

Suitable emulsifiers/solubilizers include DABCO Ketene 20AS (Air Products), and Tergitol NP-9 (nonylphenol+9 moles ethylene oxide).

### Flame Retardants

Flame Retardants may be used in the production of polyurethane and polyisocyanurate foams, especially when the foams contain flammable blowing agents such as pentane isomers. Useful flame retardants include tri(monochloropropyl) phosphate (a.k.a. tris (cloro-propyl) phosphate), tri-2-chloroethyl phosphate (a.k.a tris(chloro-ethyl) phosphate), phosphonic acid, methyl ester, dimethyl ester, and diethyl ester. U.S. Pat. No. 5,182,309 is incorporated herein by reference to show useful blowing agents.

### Blowing Agents

Useful blowing agents include isopentane, n-pentane, cyclopentane, alkanes, (cyclo) alkanes, hydrofluorocarbons, hydrochlorofluorocarbons, fluorocarbons, fluorinated ethers, alkenes, alkynes, carbon dioxide, hydrofluoroolefins (HFOs) and noble gases.

### Amount of Reactants

An isocyanurate is a trimeric reaction product of three isocyanates forming a six-membered ring. The ratio of the equivalence of NCO groups (provided by the isocyanate-containing compound or A-side) to isocyanate-reactive groups (provided by the isocyanate-containing compound or B side) may be referred to as the index or ISO index. When the NCO equivalence to the isocyanate-reactive group equivalence is equal, then the index is 1.00, which is referred to as an index of 100, and the mixture is said to be stoiciometrically equal. As the ratio of NCO equivalence to isocyanate-reactive groups equivalence increases, the index increases. Above an index of about 150, the material is generally known as a polyisocyanurate foam, even though there are still many polyurethane linkages that may not be trimerized. When the index is below about 150, the foam is generally known as a polyurethane foam even though there may be some isocyanurate linkages. For purposes of this specification, reference to polyisocyanurate and polyurethane will be used interchangeably unless a specific ISO index is referenced.

In one or more embodiments, the concentration of the isocyanate-containing compound to the isocyanate-reactive compounds within the respective A-side and B-side streams is adjusted to provide the foam product with an ISO index of at least 150, in other embodiments at least 170, in other embodiments at least 190, in other embodiments at least 210, in other embodiments at least 220, and in other embodiments at least 250. In these or other embodiments, the concentration of the isocyanate-containing compound to the isocyanate-reactive compounds within the respective A-side and B-side streams is adjusted to provide the foam product with an ISO index of at most 400, in other embodiments at most 350, and in other embodiments at most 300. In one or more embodiments, the concentration of the isocyanate-containing compound to the isocyanate-reactive compounds within the respective A-side and B-side streams is adjusted to provide the foam product with an ISO index of from about 150 to about 400, in other embodiments from about 170 to about 350, and in other embodiments from about 190 to about 330, and in other embodiments from about 220 to about 280.

In one or more embodiments, where an alkane blowing agent is employed, the amount of alkane blowing agent (e.g., pentanes) used in the manufacture of polyisocyanurate foam construction board according to the present invention may be described with reference to the amount of isocyanate-reactive compound employed (e.g., polyol). For example, in one or more embodiments, at least 12, in other embodiments at least 14, and in other embodiments at least 18 parts by weight alkane blowing agent per 100 parts by weight of polyol may be used. In these or other embodiments, at most 40, in other embodiments at most 36, and in other embodiments at most 33 parts by weight alkane blowing agent per 100 parts by weight of polyol may be used. In one or more embodiments, from about 12 to about 40, in other embodiments from about 14 to about 36, and in other embodiments from about 18 to about 33 of alkane blowing agent per 100 parts by weight of polyol may be used.

In one or more embodiments, where an hydrofluoroolefin blowing agent is employed, the amount of hydrofluoroolefin blowing agent used in the manufacture of polyisocyanurate foam construction board according to the present invention may be described with reference to the amount of isocyanate-reactive compound employed (e.g., polyol). For example, in one or more embodiments, at least 15, in other embodiments at least 18, and in other embodiments at least 20 parts by weight hydrofluoroolefin blowing agent per 100 parts by weight of polyol may be used. In these or other embodiments, at most 50, in other embodiments at most 45, and in other embodiments at most 40 parts by weight hydrofluoroolefin blowing agent per 100 parts by weight of polyol may be used. In one or more embodiments, from about 15 to about 50, in other embodiments from about 18 to about 45, and in other embodiments from about 20 to about 40 of hydrofluoroolefin blowing agent per 100 parts by weight of polyol may be used.

In one or more embodiments, the amount of surfactant (e.g., silicone copolymer) used in the manufacture of polyisocyanurate foam construction board according to the present invention may be described with reference to the amount of isocyanate-reactive compound employed (e.g., polyol). For example, in one or more embodiments, at least 1.0, in other embodiments at least 1.5, and in other embodiments at least 2.0 parts by weight surfactant per 100 parts by weight of polyol may be used. In these or other embodiments, at most 5.0, in other embodiments at most 4.0, and in other embodiments at most 3.0 parts by weight surfactant per 100 parts by weight of polyol may be used. In one or more embodiments, from about 1.0 to about 5.0, in other embodiments from about 1.5 to about 4.0, and in other embodiments from about 2.0 to about 3.0 of surfactant per 100 parts by weight of polyol may be used.

In one or more embodiments, the amount of flame retardant (e.g., liquid phosphates) used in the manufacture of polyisocyanurate foam construction board according to the present invention may be described with reference to the amount of isocyanate-reactive compound employed (e.g., polyol). For example, in one or more embodiments, at least 5, in other embodiments at least 10, and in other embodiments at least 12 parts by weight flame retardant per 100 parts by weight of polyol may be used. In these or other embodiments, at most 30, in other embodiments at most 25, and in other embodiments at most 20 parts by weight flame retardant per 100 parts by weight of polyol may be used. In one or more embodiments, from about 5 to about 30, in other embodiments from about 10 to about 25, and in other embodiments from about 12 to about 20 of flame retardant per 100 parts by weight of polyol may be used.

In one or more embodiments, the amount of catalyst(s) employed in practice of the present invention can be readily determined by the skilled person without undue experimentation or calculation. Indeed, the skilled person is aware of the various process parameters that will impact the amount of desired catalyst. Also, the amount of catalyst employed can be varied to achieve various desired properties such as the desired index.

### Characteristics of Foam Encasement

As indicated above, the foam that encases the fragile insulation materials includes a polyurethane and/or polyisocyanurate foam. As is generally understood in the art, a foam is a cellular structure that may include an interconnected network of solid struts or plates that form the edges and faces of cells. These cellular structures may, in one or more embodiments, also be defined by a “relative density” that is less than 0.8, in other embodiments less than 0.5, and in other embodiments less than 0.3. As those skilled in the art will appreciate, “relative density” refers to the density of the cellular material divided by that of the solid from which the cell walls are made. As the relative density increases, the cell walls thicken and the pore space shrinks such that at some point there is a transition from a cellular structure to one that is better defied as a solid containing isolated pores.

In one or more embodiments, the developing foam is engineered to produce a final foam structure that is characterized by a relatively low density. In one or more embodiments, this foam may have a density defined according to ASTMC 303 that is less than 2.5 pounds per cubic foot (12 kg/m²), in other embodiments less than 2.0 pounds per cubic foot (9.8 kg/m²), in other embodiments less than 1.9 pounds per cubic foot (9.3 kg/m²), and still in other embodiments less than 1.8 pounds per cubic foot (8.8 kg/m²). In one or more embodiments, foam may be characterized by having a density that is greater than 1.50 pounds per cubic foot (7.32 kg/m²) and optionally greater than 1.55 pounds per cubic foot (7.57 kg/m²).

In other embodiments, the developing foam is engineered to produce a final foam product having a relatively high density. In one or more embodiments, the foam has a density, as defined by ASTM C303, of greater than 2.5 pounds per cubic foot (12.2 kg/m²), as determined according to ASTM C303, in other embodiments the density is greater than 2.8 pounds per cubic foot (13.7 kg/m²), in other embodiments greater than 3.0 pounds per cubic foot (14.6 kg/m²), and still in other embodiments greater than 3.5 pounds per cubic foot (17.1 kg/m²). In one or more embodiments, the density may be less than 20 pounds per cubic foot (97.6 kg/m²), in other embodiments less than 10 pounds per cubic foot (48.8 kg/m²), in other embodiments less than 6 pounds per cubic foot (29.3 kg/m²), in other embodiments less than 5.9 pounds per cubic foot (28.8 kg/m²), in other embodiments less than 5.8 pounds per cubic foot (28.3 kg/m²), in other embodiments less than 5.7 pounds per cubic foot (27.8 kg/m²), in other embodiments less than 5.6 pounds per cubic foot (27.3 kg/m²), and still in other embodiments less than 5.5 pounds per cubic foot (26.9 kg/m²).

In one or more embodiments, the developing foam is engineered to provide a final foam product having a desired ISO index. As the skilled person understands, ISO index correlates to PIR/PUR ratio and can determined by IR spectroscopy using standard foams of known index (note that ratio of 3 PIR/PUR provides an ISO Index of 300), of at least 150, in other embodiments at least 180, in other embodiments at least 200, in other embodiments at least 220, in other embodiments at least 240, in other embodiments at least 260, 270, in other embodiments at least 285, in other embodiments at least 300, in other embodiments at least 315, and in other embodiments at least 325. In these or other embodiments, the foam may be characterized by an ISO index of less than 350, in other embodiments less than 300, in other embodiments less than 275, in other embodiments less than 250, in other embodiments less than 225, and in other embodiments less than 200.

In other embodiments, construction board is or includes a polymeric material. In one or more embodiments, the polymeric material is generally solid, which refers to a structure wherein the relative density is greater than 0.8, in other embodiments greater than 0.85, in other embodiments greater than 0.90, and in other embodiments greater than 0.95. In other embodiments, the polymeric material is cellular in nature, which refers to a material having a relatively density that is less than 0.8, in other embodiments less than 0.5, and in other embodiments less than 0.3. As those skilled in the art will appreciate, “relative density” refers to the density of the cellular material divided by that of the solid from which the cell walls are made. As the relative density increases, the cell walls thicken and the pore space shrinks such that at some point there is a transition from a cellular structure to one that is better defied as a solid containing isolated pores.

In one or more embodiments, foam body 16 is a relatively low-density polyurethane or polyisocyanurate foam board. As those skilled in the art appreciate, these foam boards may be generally characterized by a density as defined by ASTM C303 that is less than 2.5 pounds per cubic foot (12 kg/m²), in other embodiments less than 2.0 pounds per cubic foot (9.8 kg/m²), in other embodiments less than 1.9 pounds per cubic foot (9.3 kg/m²), and still in other embodiments less than 1.8 pounds per cubic foot (8.8 kg/m²). In one or more embodiments, the density is greater than 1.50 pounds per cubic foot (7.32 kg/m²) and optionally greater than 1.55 pounds per cubic foot (7.57 kg/m²).

In one or more embodiments, foam body 16 is a relatively high-density polyurethane or polyisocyanurate foam board. In one or more embodiments, these foam boards may be generally characterized by a density as defined by ASTM C300 that is greater than pounds per cubic foot (12.2 kg/m²), as determined according to ASTM C303, in other embodiments the density is greater than 2.8 pounds per cubic foot (13.7 kg/m²), in other embodiments greater than 3.0 pounds per cubic foot (14.6 kg/m²), and still in other embodiments greater than 3.5 pounds per cubic foot (17.1 kg/m²). In one or more embodiments, the density of body 11 may be less than 20 pounds per cubic foot (97.6 kg/m²), in other embodiments less than 10 pounds per cubic foot (48.8 kg/m²), in other embodiments less than 6 pounds per cubic foot (29.3 kg/m²), in other embodiments less than 5.9 pounds per cubic foot (28.8 kg/m²), in other embodiments less than 5.8 pounds per cubic foot (28.3 kg/m²), in other embodiments less than 5.7 pounds per cubic foot (27.8 kg/m²), in other embodiments less than 5.6 pounds per cubic foot (27.3 kg/m²), and still in other embodiments less than 5.5 pounds per cubic foot (26.9 kg/m²).

### Facer

The construction of facers 22, 24 can be the same or different. In one or more embodiments, facer 22 (and optionally optional facer 24) may include a variety of materials or compositions, many of which are known or conventional in the art. Useful facers include those comprising aluminum foil, cellulosic fibers, reinforced cellulosic fibers, craft paper, coated glass fiber mats, uncoated glass fiber mats, chopped glass, and combinations thereof. Useful facer materials are known as described in U.S. Pat. Nos. 6,774,071, 6,355,701, RE 36,674, 6,044,604, and 5,891,563, which are incorporated herein by reference.

The thickness of the facer material may vary; for example, it may be from about 0.01 to about 1.00 inches thick (0.025-2.54 cm) or in other embodiments from about 0.015 to about 0.050 inches thick (0.04-0.13 cm), or in other embodiments from about 0.015 to about 0.030 inches thick (0.04-0.07 cm). The facer materials can also include more robust or rigid materials such as fiber board, perlite board, or gypsum board. The thickness of the rigid facer can vary; for example, the thickness of the rigid facer can be from about 0.2 to about 1.5 inches (0.51-3.8 cm), or in other embodiments from about 0.25 to about 1.0 inches (0.64-2.54 cm).

In one or more embodiments, facers 22 and 24 are optional. Therefore, in one or more embodiments, construction board 10 may be facerless. The ability to produce facerless construction boards is known as described in U.S. Pat. No. 6,117,375, which is incorporated herein by reference.

In other embodiments, facers 22, 24 may be generally solid material such as wood, particle, or fiber board. In one or more embodiments, the facer is a wood board such as plywood, luan board, or oriented-strand board (OSB). In other embodiments, the facer board is a particle or fiber board such as masonite board, wall board, gypsum board, and variations thereof such as those boards available under the tradename DensDeck.

In yet other embodiments, at least one of facers 22, 24 include a foamed construction board such as a polyurethane/polyisocyanurate foamed insulation or coverboard. In this respect, U.S. Pat. No. 7,972,688, and U.S. Publication No. 2006/0096205 are incorporated herein by reference.

Particular embodiments can be described with reference to FIG. 2. Here, composite 40 includes VIPs 42, 42′, which each include, respectively, encapsulating elements 44, 44′, and rigid elements 45, 45′. VIPs 42, 42′ are partially encased in foam 46, which may be referred to as foam body 46. Foam body 46 includes an upper planar surface 47 to which facer 52 is attached. Foam body 46 also includes a lower planar surface 48 to which construction board 60 is attached and to which VIPs 42, 42′ are adjacently positioned. Construction board 60 includes first facer 64, second facer 66, and foam body 62 disposed therebetween. The layer of pressure-sensitive adhesive 50 is disposed on second facer 66 on a planar surface thereof opposite the planar surface where facer 66 is secured to foam body 62. A release member 54 is removably attached to adhesive layer 50 on a planar surface thereof opposite the planar surface where adhesive layer 50 is disposed on facer 66.

### Adhesive Layer

In one or more embodiments, the adhesive layer (e.g. layer 30, 50) is a pressure-sensitive adhesive. In particular embodiments, the adhesive layer includes a 100 percent solids tape. These tapes are known in the art and may include, as major polymeric component, a rubber such as ethylene-propylene-diene rubber, ethylene-propylene rubber, polychloroprene, and/or butyl rubber. Exemplary solids tapes are disclosed in U.S. Pat. Nos. 9,296,927, 9,068,038, 8,347,932, and 5,859,114, which are incorporated herein by reference.

In other embodiments, the adhesive layer (e.g. layer 30, 50) is hot-melt pressure-sensitive adhesive composition. Exemplary pressure-sensitive adhesive compositions that may be employed in practicing the present invention include those compositions based upon acrylic polymers, butyl rubber, ethylene vinyl acetate, natural rubber, nitrile rubber, silicone rubber, styrene block copolymers, ethylene-propylene-diene rubber, atactic polyalpha olefins, and/or vinyl ether polymers. In combination with these base polymers, the pressure-sensitive adhesive compositions may include a variety of complementary constituents such as, but not limited to, tackifying resins, waxes, antioxidants, and plasticizers. Pressure-sensitive adhesives that are useful in practicing the present invention are known in the art as described, for example, in U.S. Pat. No. 8,968,853, which is incorporated herein by reference.

In one or more embodiments, the thickness of pressure-sensitive adhesive layer 30 may be at least 15 μm, in other embodiments at least 30 μm, in other embodiments at least 45 μm, and in other embodiments at least 60 μm. In these or other embodiments, the thickness of pressure-sensitive adhesive layer 30 may be at most 1000 μm, in other embodiments at most 600 μm, in other embodiments at most 300 μm, in other embodiments at most 150 μm, and in other embodiments at most 75 μm. In one or more embodiments, the thickness of pressure-sensitive adhesive layer 30 may be from about 15 μm to about 600 μm, in other embodiments from about 15 μm to about 1000 μm, in other embodiments from about 30 μm to about 300 μm, and in other embodiments from about 45 μm to about 150 μm.

In particular embodiments, adhesive layer 30 is a cured, hot-melt pressure sensitive adhesive. Cured pressure-sensitive adhesives that are useful in practicing the present invention are known in the art as described, for example, in WIPO Publ. No. WO 2015/042258, which is incorporated herein by reference.

In one or more embodiments, the curable hot-melt adhesive that may be used for forming the cured pressure-sensitive adhesive layer may be an acrylic-based hot-melt adhesive. In one or more embodiments, the adhesive is a polyacrylate such as a polyacrylate elastomer. In one or more embodiments, useful polyacrylates include one or more units defined by the formula:

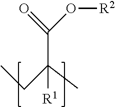

where each R¹ is individually hydrogen or a hydrocarbyl group and each R² is individually a hydrocarbyl group. In the case of a homopolymer, each R¹ and R², respectively, throughout the polymer are same in each unit. In the case of a copolymer, at least two different R¹ and/or two different R² are present in the polymer chain.

In one or more embodiments, hydrocarbyl groups include, for example, alkyl, cycloalkyl, substituted cycloalkyl, alkenyl, cycloalkenyl, substituted cycloalkenyl, aryl, substituted aryl, aralkyl, alkaryl, allyl, and alkynyl groups, with each group containing in the range of from 1 carbon atom, or the appropriate minimum number of carbon atoms to form the group, up to about 20 carbon atoms. These hydrocarbyl groups may contain heteroatoms including, but not limited to, nitrogen, oxygen, boron, silicon, sulfur, and phosphorus atoms. In particular embodiments, each R² is an alkyl group having at least 4 carbon atoms. In particular embodiments, R¹ is hydrogen and R² is selected from the group consisting of butyl, 2-ethylhexyl, and mixtures thereof.

In one or more embodiments, the polyacrylate elastomers that are useful as adhesives in the practice of this invention may be characterized by a glass transition temperature (Tg) of less than 0° C., in other embodiments less than −20° C., in other embodiments less than −30° C. In these or other embodiments, useful polyacrylates may be characterized by a Tg of from about −70 to about 0° C., in other embodiments from about −50 to about −10° C., and in other embodiments from about −40 to about −20° C.

In one or more embodiments, the polyacrylate elastomers that are useful as adhesives in the practice of this invention may be characterized by a number average molecular weight of from about 100 to about 350 kg/mole, in other embodiments from about 150 to about 270 kg/mole, and in other embodiments from about 180 to about 250 kg/mole.

In one or more embodiments, the polyacrylate elastomers that are useful as adhesives in the practice of this invention may be characterized by a Brookfield viscosity at 150° C. of from about 20,000 to about 70,000 cps, in other embodiments from about 30,000 to about 60,000 cps, and in other embodiments from about 40,000 to about 50,000 cps.

Specific examples of polyacrylate elastomers that are useful as adhesives in the practice of the present invention include poly(butylacrylate), and poly(2-ethylhexylacryalte). These polyacrylate elastomers may be formulated with photoinitiators, solvents, plasticizers, and resins such as natural and hydrocarbon resins. The skilled person can readily formulate a desirable coating composition. Useful coating compositions are disclosed, for example, in U.S. Pat. Nos 6,720,399, 6,753,079, 6,831,114, 6,881,442, and 6,887,917, which are incorporated herein by reference.

In other embodiments, the polyacrylate elastomers may include polymerized units that serve as photoinitiators. These units may derive from copolymerizable photoinitiators including acetophenone or benzophenone derivatives. These polyacrylate elastomers and the coating compositions formed therefrom are known as disclosed in U.S. Pat. Nos 7,304,119 and 7,358,319, which are incorporated herein by reference.

Useful adhesive compositions are commercially available in the art. For example, useful adhesives include those available under the tradename acResin (BASF), those available under the tradename AroCure (Ashland Chemical), and NovaMeltRC (NovaMelt). In one or more embodiments, these hot-melt adhesives may be cured (i.e., crosslinked) by UV light.

In one or more embodiments, the hot-melt adhesive is at least partially cured after being applied to the membrane, as will be discussed in greater detail below. In one or more embodiments, the adhesive is cured to an extent that it is not thermally processable in the form it was prior to cure. In these or other embodiments, the cured adhesive is characterized by a cross-linked infinite polymer network. While at least partially cured, the adhesive layer of one or more embodiments is essentially free of curative residue such as sulfur or sulfur crosslinks and/or phenolic compounds or phenolic-residue crosslinks.

### Release Member

In one or more embodiments, the release liner (e.g. liner 34), which may also be referred to as release member 34, includes a polymeric film or extrudate. This polymeric film or extrudate may include a single polymeric layer or may include two or more polymeric layers laminated or coextruded to one another. In other embodiments, the release liner includes a cellulosic substrate having a polymeric film or coating applied thereon, which film or coating may be referred to as a polymeric layer. The polymeric layer may be a single layer or include multiple layers.

Suitable materials for forming a release liner that is a polymeric film or extrudate include polypropylene, polyester, high-density polyethylene, medium-density polyethylene, low-density polyethylene, polystyrene or high-impact polystyrene. Suitable materials for forming a polymeric layer on a cellulosic-based release liner include siloxane-based materials, butadiene-based materials, organic materials (e.g., styrene-butadiene rubber latex), as well as those polymeric materials employed to form a film or extrudate as described above. These polymeric materials may offer a number of advantageous properties including high moisture resistance, good resistance to temperature fluctuations during processing and storage, and increased tear and wrinkle resistance. The above referenced films and materials may be coated with a release agent, (e.g., silicone).

In one or more embodiments, the release member is characterized by a thickness of from about 15 to about 80, in other embodiments from about 18 to about 75, and in other embodiments from about 20 to about 50 μm.

### Method of Manufacture

In one or more embodiments, the composite insulation boards of the present invention are generally manufactured by employing techniques that are known by those skilled in the art, which techniques generally include the use of a laminator. As the skilled person understands, a developing foam is formed by combining an A-side stream with a B-side stream, as generally described above. These streams are typically combined within one or more mix heads, and then the developing foam is deposited onto a facer, which is being carried by the laminator. After sufficient foam is deposited, and a desirable rise time is provided, a second facer is positioned over the developing foam. This composite structure is then fed into an oven to provide an appropriate environment to cure the foam. Methods for including VIPs into these foam structures are known as described in WO 2015/153568 and U.S. 2013/0089696, which are incorporated herein by reference.

According to aspects of the present invention, one or both of the facers are provided with a layer of adhesive prior to introducing the developing foam to the facer. For example, the adhesive can be coated to a facer material (e.g., a cellulosic or glass mat), and then a release member is removably adhered to the fabric material. In one or more embodiments, where the adhesive is UV-curable, the coated facer is subjected to UV-curing conditions to affect curing of the adhesive layer, and then the release liner is subsequently adhered to the cured adhesive layer. This composite (i.e., the facer substrate, adhesive layer, and the release liner) is then placed into the laminator to receive the developing foam (or, alternatively, the foam composite is applied over the developing foam within the laminator. In other embodiments, the insulation board (with the VIPs encased thereon) are first fabricated (e.g., within a laminator) and then the adhesive layer and release member are subsequently applied to one or both of the facers.

### INDUSTRIAL APPLICABILITY

In one more embodiments, the insulating devices of the invention can be fabricated into insulating devices for use in the construction industry. For example, the insulating devices can be fabricated into construction boards that can be used as insulating devices for roof and wall applications. Thus, embodiments of the present invention are directed toward a building structure having the insulation devices of this invention installed therein.

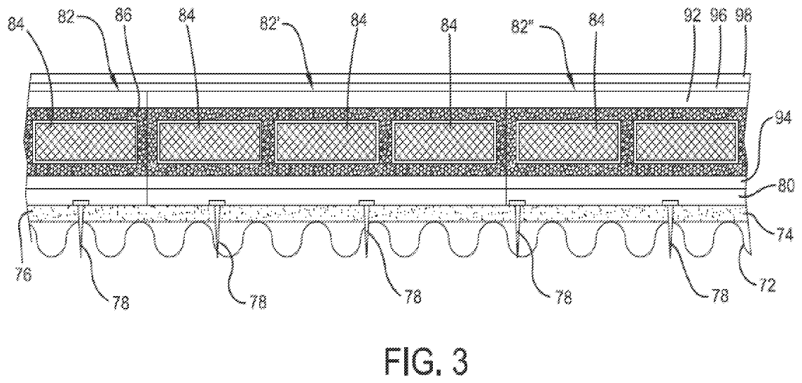

An exemplary roof structure according to aspects of the present invention can be described with reference to FIG. 3, which shows roof assembly 70 including roof deck 72, construction board 74, 74′, composite boards 82, 82′, 82″, optional coverboard 96 and membrane 98. Construction boards 74, 74′ are mechanically attached to roof deck 72 via mechanical fasteners 78. Composites 82, 82′, 82″ each respectively include VIPs 84, foam body 86, first facer 92, second facer 94, and adhesive layer 80. Adhesive layer 80 adhesively binds second facer 94 to construction boards 74, 74′. As described above, construction boards 74, 74′ may include foamed cellular construction boards, which may carry a pair of opposed facers, one of which would be adhesively bonded to adhesive layer 80.

Practice of this invention is not limited by the selection of any particular roof deck. Accordingly, the roofing systems herein can include a variety of roof decks. Exemplary roof decks include concrete pads, steel decks, wood beams, and foamed concrete decks.

Fasteners that are conventionally used in the art may be used in practice of this invention. In one or more embodiments, the mechanical fasteners which may be referred to as mechanical fastening systems, may include penetrating and non-penetrating mechanical fasteners. In one or more embodiments, these fastening systems include a penetrating fastening system that includes an anchoring member or fastener for penetrating the roof deck, such as a self-drilling and self-tapping screw-threaded fastener or pneumatically-driven nail or staple (optionally including an anchoring mechanism); these fasteners may include a driving head. The anchor member may include a complementary engaging element for dispersing load to the bonding assembly. In one or more embodiments, the complementary engaging element includes an elongated fastening bar or strip. In other embodiments, the complementary engaging element includes a circular plate. Useful mechanical fasteners are known in the art as described in U.S. Pat. Nos. 4,445,306, 4,074,501, 4,455,804, 4,467,581, 4,617,771, 4,744,187, 4,862,664 and 5,035,028 which are incorporated herein by reference. Useful non-penetrating fasteners include those described in U.S. Pat. Nos. 3,426,412, 4,619,094, and 4,660,347, which are incorporated herein by reference.

Practice of this invention is likewise not limited by the selection of any water-protective layer or membrane. As is known in the art, several membranes can be employed to protect the roofing system from environmental exposure, particularly environmental moisture in the form of rain or snow. Useful protective membranes include polymeric membranes. Useful polymeric membranes include both thermoplastic and thermoset materials. For example, and as is known in the art, membrane prepared from poly(ethylene-co-propylene-co-diene) terpolymer rubber or poly(ethylene-co-propylene) copolymer rubber can be used. Roofing membranes made from these materials are well known in the art as described in U.S. Pat. Nos. 6,632,509, 6,615,892, 5,700,538, 5703,154, 5,804,661, 5,854,327, 5,093,206, and 5,468,550, which are incorporated herein by reference. Other useful polymeric membranes include those made from various thermoplastic polymers or polymer composites. For example, thermoplastic olefin (i.e. TPO), thermoplastic vulcanizate (i.e. TPV), or polyvinylchloride (PVC) materials can be used. The use of these materials for roofing membranes is known in the art as described in U.S. Pat. Nos. 6,502,360, 6,743,864, 6,543,199, 5,725,711, 5,516,829, 5,512,118, and 5,486,249, which are incorporated herein by reference. In one or more embodiments, the membranes include those defined by ASTM D4637-03 and/or ASTM D6878-03.

In one or more embodiments, the construction boards of the present invention can be installed by employing peel-and-stick installation techniques. For example, the release member can be removed from the construction board, and then the board is adhered or mated to the roof substrate, which may include a roof deck (e.g., wood or concrete), an underlying construction board, or an existing membrane. Accordingly, embodiments of the present invention provide a method for creating a roof system that includes mechanically affixing a construction board to a roof deck and then adhesively securing a layer of composite insulation board to the construction board through an adhesive layer that is factory-applied to the composite insulation board. Where a membrane in affixed to the underlying roof system through a factory-applied adhesive, the present invention uniquely offers a method that can form a fully adhered roof system without the release of any appreciable VOC during installation.

Various modifications and alterations that do not depart from the scope and spirit of this invention will become apparent to those skilled in the art. This invention is not to be duly limited to the illustrative embodiments set forth herein.

What is claimed is:

1. A method of constructing a roof assembly, the method comprising:
i. mechanically affixing a construction board to a roof deck;
ii. providing a composite insulation board including:
(a) at least one vacuum-insulated capsule;
(b) a foam body that encases said at least one vacuum-insulated capsule, said foam body having first and second opposed planar surfaces;
(c) a layer of pressure-sensitive adhesive disposed, either directly or indirectly, on one of said first and second opposed planar surfaces; and
(d) a release liner removably attached to the layer of pressure-sensitive adhesive;
iii. removing the release liner from the composite insulation board;
iv. mating the composite insulation board to the construction board that is mechanically affixed to the roof deck; and
v. installing a membrane system over the composite insulation board.

2. The method of claim 1, further comprising the step of providing a membrane carrying a factory-applied adhesive system and a release liner removably attached over the adhesive system, where said step of installing includes removing the release liner from the membrane and mating the membrane to the composite insulation board.

3. The method of claim 1, further comprising the step of installing a coverboard over the composite insulation board.

4. The method of claim 1, where the pressure-sensitive adhesive is a UV-cured adhesive layer.

5. The method of claim 1, wherein said composite insulation board further includes a first facer secured to said first opposed planar surface and a second facer secured to said second opposed planar surface and wherein said layer of pressure-sensitive adhesive is disposed on said second facer.

6. The method of claim 5, wherein said composite insulation board has a thickness of from about 0.25 inches to about 12 inches.

7. The method of claim 1, wherein said foam body includes an insulating foam selected from polyurethane or polyisocyanurate.

8. The method of claim 7, wherein said step of providing a composite insulation board includes manufacturing the insulating foam by mixing a first stream that includes an isocyanate-containing compound with a second stream that includes an isocyanate-reactive compound.

9. The method of claim 1, wherein said foam body completely encases said at least one vacuum-insulated capsule.

10. The method of claim 1, wherein said foam body partially encases said at least one vacuum-insulated capsule.

11. The method of claim 1, wherein said step of providing a composite insulation board includes manufacturing the at least one vacuum-insulated capsule by providing a core material, surrounding the core material with a membrane material to form a chamber, and evacuating air from the chamber to form the at least one vacuum-insulated capsule.
